(19) United States
(12) Patent Application Publication
(10) Pub. No.: US 2004/0151657 A1
(43) Pub. Date: Aug. 5, 2004

(54) Process for regenerating thiosulphate from a gold leaching stream

(76) Inventors: Cees Jan Nico Buisman, Harich (NL); Merijn Amilcare Picavet, Sneek (NL)

Correspondence Address: YOUNG & THOMPSON, 745 SOUTH 23RD STREET 2ND FLOOR, ARLINGTON, VA, 22202

(21) Appl. No.: 10/743,024

(22) Filed: Dec. 23, 2003

(30) Foreign Application Priority Data
Dec. 23, 2002 (EP) 02080458.9

(51) Int. Cl. C01B 17/02

(52) U.S. Cl. 423/571

(57) ABSTRACT

A new process of regenerating thiosulphate from a spent thiosulphate solution comprises the steps of:

(a) reacting the spent thiosulphate solution with sulphide to produce elemental sulphur and a regenerated thiosulphate solution,

(b) separating the elemental sulphur from the regenerated thiosulphate solution,

(c) biologically reducing the separated elemental sulphur to produce sulphide, and

(d) returning the sulphide from step (c) to step (a).

This can be applied in a process of extracting noble metals such as gold from a gold-containing slurry by contacting the slurry with a solution containing thiosulphate ions and oxygen to produce a gold thiosulphate solution, contacting the gold thiosulphate solution with an absorbent to produce a gold-loaded absorbent and spent thiosulphate, recovering gold from the gold-loaded absorbent, and regenerating the thiosulphate as described above.

The present invention relates to a process of regenerating a thiosulphate solution, that can be used for example in processes for leaching noble metals such as gold leaching and silver leaching,

Significant quantities of gold ore contain sulphidic minerals such as arsenopyrite (FeAsS), pyrite and marcasite (FeS₂). These minerals can contain encapsulated gold. This gold is too fine to be liberated by grinding only. This problem is usually overcome trough pressure oxidation, which allows the sulphide minerals present in the ore to be oxidised in an aqueous slurry at elevated temperature and oxygen pressure (U.S. Pat. No. 5,071,477). Subsequently the gold present can be readily leached using common leaching agents, rendering the process economical. Typically, pressure oxidation is done under acidic conditions in a multi-compartmented autoclave.

Gold leaching from gold-bearing pressure-oxidised slurries is usually performed using cyanide ions or thiosulphate ions as leaching agents. Typically, the pH of the slurry is adjusted to 10 to 11 when lime and cyanide is added to solubilise the gold. The following reaction applies.

4Au+O₂+8CN⁻+2H₂O→4Au(CN)₂⁻+4HO⁻

After leaching, gold is recovered usually through absorption onto activated carbon. However, some ores contain active carbon themselves and can absorb part of the solubilised gold and thus reduce gold recovery. These ores are called carbonaceous ores and the phenomenon of back-absorption is called preg-robbing. Therefore, for carbonaceous ores preferably a different leaching agent is used.

A leaching agent for gold recovery from carbonaceous ores which does not have the above mentioned drawback is thiosulphate e.g. in the form of ammonium thiosulphate ((NH₄)₂S₂O₃). A process of extracting silver or gold from ores containing other metals such as manganese, is described in U.S. Pat. No. 4,369,061.

Typical thiosulphate concentrations in the extracting solutions range from 0.03 to 0.05 M. The following solubilisation reaction applies:

4Au+O₂+8S₂O₃²⁻+2H₂O→4Au(S₂O₃)₂³⁻+4HO⁻

According to U.S. Pat. No. 5,785,736, the pressure-oxidised slurry typically contains 30 to 45% solids, has a temperature between 45 and 60° C. and a pH between 7 and 8.7. The solubilisation takes place in the presence of copper, which serves as a catalyst.

Subsequently, gold is extracted from the gold-bearing solution through absorption onto an anion exchange resin. The loaded resin is separated from the barren leachate for gold recovery.

A considerable problem encountered when using thiosulphate as a leaching agent is its high consumption due to its instability, The reaction mainly responsible for this is the oxidation of thiosulphate to tetrathionate:

2(NH₄)₂S₂O₃+½O₂+H₂O→(NH₄)₂S₄O₆+2NH₄OH

In the presence of hydroxide ions, the unstable tetrathionate decomposes into trithionate and thiosulphate:

4(NH₄)₂S₄O₆+6NH₄OH→5(NH₄)₂S₂O₃+2(NH₄)₂S₃O₆+3H₂O

Trithionate is also unstable. It decomposes according to the following reaction into thiosulphate and sulphate:

(NH₄)₂S₃O₆+2NH₄OH→(NH₄)₂S₂O₃+(NH₄)₂SO₄+H₂O

Overall, thiosulphate is oxidised to sulphate:

(NH₄)₂S₂O₃+2O₂+2NH₄OH→2(NH₄)₂SO₄+H₂O

Reversing the oxidation reaction of thiosulphate to tetrathionate using a suitable reductant can lower thiosulphate consumption. This reaction can be reversed by adding ammonium sulphite (NH₄)₂SO₃) to the leaching liquid. Sulphite reduces tetrathionate according to the following reaction:

(NH₄)₂S₄O₆+2NH₄OH+(NH₄)₂SO₃→2(NH₄)₂S₂O₃+(NH₄)₂SO₄+H₂O

Thus, sulphite is consumed and oxidised to sulphate. This reaction takes place during the leaching process. Instead of sulphite, sulphide an also be used for regenerating thiosulphate. The following reaction applies then:

(NH₄)₂S₄O₆+H₂S+2NH₄OH→2(NH₄)₂S₂O₃+S⁰+2H₂O

Possible sources of sulphide are sodium hydrosulphide or pressurised hydrogen sulphide. These sources have drawbacks in that they are difficult to handle and need storage space involving safety measures.

It was found according to the invention that the efficacy of a thiosulphate regeneration process can be increased by using biologically produced hydrogen sulphide (H₂S) as a reductant and by subsequently using the resulting elemental sulphur in the biological hydrogen sulphide production.

The big advantage of using biologically produced H₂S is that no storage facilities are required. Production takes place on demand. In addition, solid elemental sulphur S⁰ is produced, and this can be separated from the liquid and used as a feedstook for biological H₂S production. In other words, H₂S can be regenerated using a suitable reducing agent:

S⁰+electron donor→H₂S+oxidised products

Thus, the invention pertains to a process of regenerating thiosulphate from a spent thiosulphate solution, comprising the steps of:

(a) reacting the spent thiosulphate solution with sulphide to produce elemental sulphur and a regenerated thiosulphate solution,

(b) separating the elemental sulphur from the regenerated thiosulphate solution,

(c) biologically reducing the separated elemental sulphur to produce sulphide, and

(d) returning the sulphide from step (c) to step (a).

In this context, a spent thiosulphate solution is a solution or dispersion resulting from a thiosulphate-consuming process. It will contain tetrathionate and/or other polythionates, in addition to residual amounts of thiosulphate and other compounds. The regenerated thiosulphate is typically used in the thiosulphate consuming process.

The process of regenerating thiosulphate can be used advantageously in a process of extracting gold form a gold-containing slurry. This can be achieved by contacting the slurry with a solution containing thiosulphate ions and oxygen to produce a gold thiosulphate solution, separating the gold from the gold thiosulphate solution to produce a spent thiosulphate solution and then regenerating the thiosulphate using the process of the invention.

The gold-containing slurry may contain between 10 and 50 wt. % of solids, including gold particles. The gold content of the ore may be between 2 and 200 g of gold/ton. The slurry is contacted with a solution containing between 0.01 and 0.10, especially between 0.03 and 0.06 mol/l of thiosulphate. The thiosulphate may be in any form, including an alkali metal salt or ammonium salt. Oxygen is suitably supplied by aeration, at such a rate that between 0.5 and 1 mol of oxygen is fed per mol of thiosulphate.

The gold leaching may be assisted by addition of copper as a catalyst. Copper metal or copper salts, such as CuSO₄ or CuCl₂, can be used for this purpose. The copper concentration should preferably be kept in the range of 10-100 ppm.

The solubilised gold is then absorbed on an absorbent such as an anion exchange resins. The loaded absorbent is separated from the leaching solution by settling, e.g. using a clarifier.

The spent thiosulphate solution wherein part of the thiosulphate has been converted to tetrathionate or trithionate is treated with sulphide. The sulphide is produced at the leaching site by biological reduction of elemental sulphur. Such biological production of sulphide can be performed as described in WO 00/29605. The electron donor may be hydrogen, or an alcohol, such as methanol or ethanol, preferably ethanol, or an organic acid, especially a fatty acid such as acetic acid. The selection of the electron donor depends on the sulphur load: at high sulphur loads, hydrogen gas is the preferred electron donor, whereas acetic acid is preferred at relatively sulphur loads.

To ensure biogenic production of H₂S, nutrients necessary for biological growth and maintenance are provided. When acetic acid or ethanol is used, only a phosphorus source, a nitrogen source and some trace elements need to be provided. In the case of hydrogen gas a carbon source (e.g. acetic acid) needs to be added as well. A commonly used phosphorus source is phosphate (PO₄³⁻). A commonly used nitrogen source is ammonium (NH₄⁺). Commercially available nutrient mixtures, such as Nutrimix® (Paques) nutrient solution, can serve as a source for trace elements. The pH in the bioreactor can be about neutral, e.g. between 5 and 9, especially between 6 and 8. A pH controlling agent may added, e.g. in combination with the acetic acid or other nutrient. The total solids concentration is preferably between 5 and 20 g/l, which is adjusted, as necessary, by adding water as such or in combination with the nutrients.

The anaerobic biomass necessary for the biological production of sulphide from sulphur, can be obtained from common sources, e.g. existing sulphur-reducing or sulphide-oxidising bioreactors. These can comprise bacteria e.g, from the genera Desulforomonas or Desulfotomaculum. The bacteria may be mesophilic or thermophilic e.g. Desulfotomaculum KT7. Suitable bacteria are described e.g. in WO 00/29605.

The process of the invention can be performed in two modes. Firstly, the process can comprise the following process:

1. Biological H₂S production from elemental sulphur in a BSG (Biological Sulphide Generator).

2. A contactor where the barren leaching solution is contacted with H₂S to reduce tetrathionate to thiosulphate. A by-product is elemental sulphur.

3. A solid liquid separator where elemental sulphur is separated from the liquid and led back to the BSG.

4. The gold leaching where gold is leached using thiosulphate.

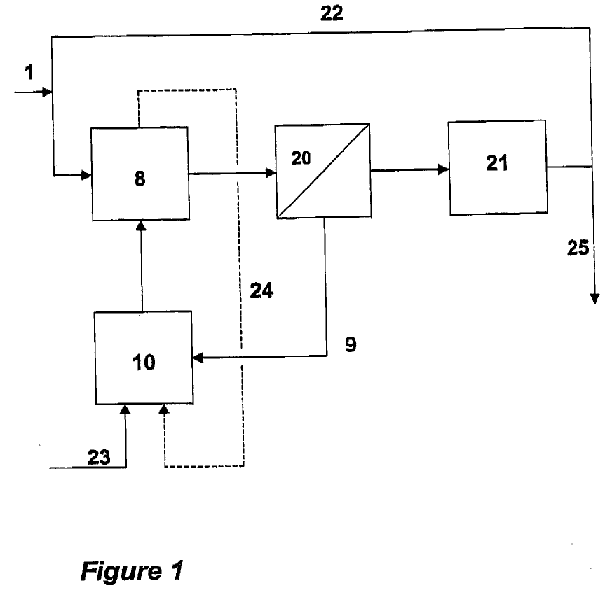

This is schematically shown in FIG. 1.

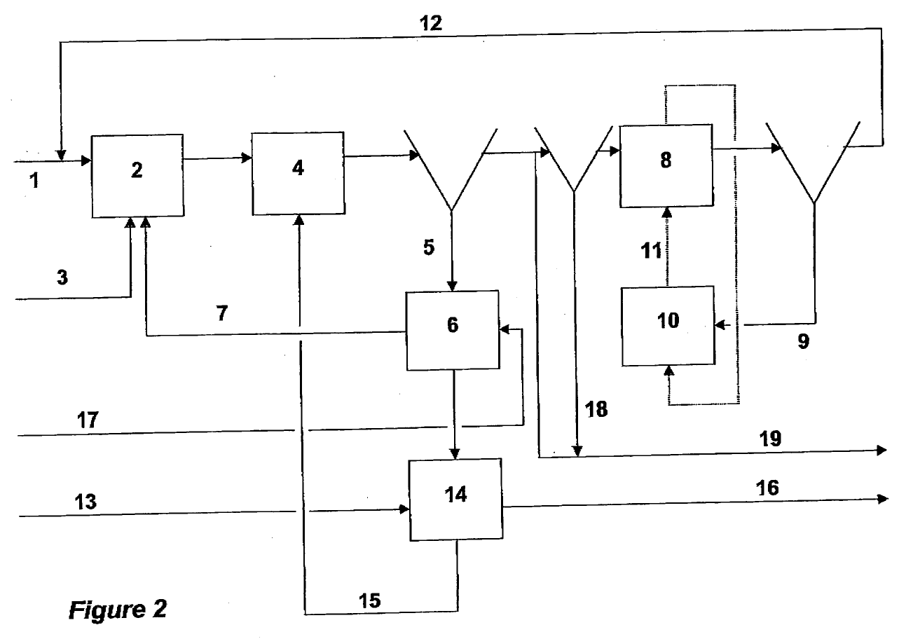

In FIGS. 1 and 2, the reference numbers denote the following:

1: Slurry feed

2: Air supply

3: Leaching

4: Absorption

5: Loaded resin

6: Copper elation

7: Copper recycle

8: Contactor

9: Elemental sulphur

10: BSG

11: Hydrogen sulphide

12: Ammonium thiosulphate recycle

13: Potassium cyanide solution

14: Gold recovery

15: Resin recycle

16: To gold recovery

17: Ammonium thiosulphate solution

18: Pulp

19: To tailings pond

20: Separator

21: Gold leaching

22: Liquid recycle

23: Electron donor and nutrients

24: Gas recycle

25: Process bleed

FIG. 2 shows a second mode of the process of the invention, and shows a more detailed flow scheme. A pressure-oxidised slurry (1) is mixed with an ammonium thiosulphate recycle (12) and fed to the leaching phase (2). Air (3) is sparged to provide the necessary oxygen for the solubilisation of the gold. Furthermore, a copper recycle (7) is led to the leaching phase as a catalyst. After leaching, the solubilised gold is absorbed onto a suitable anion exchange resin in an absorption stage (4). The loaded resin is separated from the liquid and pulp. The liquid goes to the thiosulphate regeneration, while the resin goes to the gold recovery.

First, the loaded resin (5) is treated with an ammonium thiosulphate solution (17) to elute the copper (6). This solution is then recycled to the leaching stage (2) providing the copper catalyst and fresh ammonium thiosulphate. After the copper has been eluted, the resin goes to the gold recovery stage (14). Here, the resin is contacted with a potassium cyanide solution (13) and the gold goes into solution again. The gold-bearing solution goes to the actual gold recovery (16).

After the resin has been separated, part of the slurry goes directly to the tailings pond (19). The rest is fed to a separation stage where the pulp (18) is separated from the liquid. The remaining liquid goes to a contactor (8) where it is contacted with H₂S-bearing gas (11) coming from a biological sulphide generator (11). The sulphide reacts with tetrathionate present and forms solid elemental sulphur S⁰. Subsequently, the sulphur is separated (9) and serves again as feed for the BSG. The liquid is recycled (12) to the gold leaching stage.

1. A process of regenerating thiosulphate from a spent thiosulphate solution by reacting the spent thiosulphate solution with a sulphide source, comprising the steps of:
(a) reacting the spent thiosulphate solution with sulphide to produce elemental sulphur and a regenerated thiosulphate solution,
(b) separating the elemental sulphur from the regenerated thiosulphate solution,
(c) biologically reducing the separated elemental sulphur to produce sulphide, and
(d) returning the sulphide from step (c) to step (a).

2. A process according to claim 1, wherein hydrogen, an alcohol or an organic acid is used as an electron donor in the biological reduction step (c).

3. A process according to claim 1 or 2, wherein the regenerated thiosulphate solution resulting from step (b) has a thiosulphate concentration between 0.01 and 0.10 M.

4. A process of extracting a noble metal from a metal-containing slurry, by contacting the slurry with a solution containing thiosulphate ions and oxygen to produce a metal thiosulphate solution, separating the noble metal from the metal thiosulphate solution to produce a spent thiosulphate solution, characterised by regenerating the spent thiosulphate solution by the process of any one of claims 1-3.

5. A process according to claim 4, wherein the noble metal is separated from the thiosulphate solution by contacting the metal thiosulphate solution with an absorbent and recovering noble metal from the metal-loaded absorbent.

6. A process according to claim 5, wherein the absorbent is an anion exchange resin, which after step (c) is returned to step (b).

7. A process according to claim 5 or 6, for extracting gold, wherein the absorbent contacting is carried out in the presence of copper ions, and copper ions are subsequently eluted from the gold-loaded absorbent.
